(19) United States
(12) Patent Application Publication
(10) Pub. No.: US 2025/0039910 A1
(43) Pub. Date: Jan. 30, 2025

(54) POWER ALLOCATION FOR PSFCH IN MULTI-CARRIER COMMUNICATION

(71) Applicant: APPLE INC., Cupertino, CA (US)

(72) Inventors: Chunxuan Ye, San Diego, CA (US); Dawei Zhang, Saratoga, CA (US); Haitong Sun, Cupertino, CA (US); Wei Zeng, Saratoga, CA (US); Hong He, San Jose, CA (US); Ankit Bhamri, Bad Nauheim (DE); Oghenekome Oteri, San Diego, CA (US)

(21) Appl. No.: 18/783,776

(22) Filed: Jul. 25, 2024

Related U.S. Application Data
(60) Provisional application No. 63/515,744, filed on Jul. 26, 2023.

(51) Int. Cl. H04W 72/40; H04W 52/36; H04W 72/566

(52) U.S. Cl. CPC H04W 72/40; H04W 52/367; H04W 72/566

(57) ABSTRACT

Apparatus and methods are provided for a user equipment (UE) to control sidelink power allocation on multiple carriers. The UE determines, from among a plurality of physical sidelink feedback channels (PSFCHs) scheduled for simultaneous transmission on the multiple carriers, prioritized PSFCHs to simultaneously transmit across the multiple carriers based at least in part on a capability of the UE for a maximum number of simultaneous PSFCH transmissions per carrier of the multiple carriers and a total transmission power P_{CMAX} of the UE, where j is an index of a jth-carrier of the multiple carriers. The UE determines allocated transmission power for the prioritized PSFCHs. Then, the UE simultaneously transmits the prioritized PSFCHs on the multiple carriers according to the allocated transmission power.

### CROSS-REFERENCE TO RELATED APPLICATION(S)

This application claims the benefit of U.S. Provisional Patent Application No. 63/515,744, filed Jul. 26, 2023, which is hereby incorporated by reference herein in its entirety.

### TECHNICAL FIELD

This application relates generally to wireless communication systems, including systems with sidelink feedback.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Certain wireless systems use a sidelink interface (e.g., a PC5 interface) for direct communication between UEs. In the physical layer, LTE and NR sidelink may use resource pools to configure resources for transmission and reception on a sidelink carrier. A sidelink transmission may include a physical sidelink control channel (PSCCH) transmission and physical sidelink shared channel (PSSCH) transmission. NR sidelink may use two-stage sidelink control information (SCI), wherein a first stage SCI part is sent on the PSCCH and a second stage SCI part is multiplexed with a sidelink shared channel (SL-SCH) and transmitted on the associated PSSCH. In certain systems, the NR sidelink supports hybrid automatic repeat request (HARQ) feedback for unicast and groupcast communications via a physical sidelink feedback channel (PSFCH).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example method for NR sidelink power allocation for PSFCH used in certain wireless systems.

FIG. 2 illustrates an example method for PSFCH power allocation on multiple carries, according to certain embodiments.

FIG. 3 illustrates an example of a second embodiment for power allocation for PSFCH transmission, according to certain embodiments.

FIG. 4 illustrates an example architecture of a wireless communication system, according to certain embodiments.

FIG. 5 illustrates a system for performing signaling between a wireless device and a network device, according to certain embodiments.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### NR Sidelink Operations

Certain wireless systems support NR sidelink carrier aggregation (CA) operation based on LTE sidelink CA operation. Certain LTE sidelink CA features may be supported for NR. These features may include, but are not limited to, for example, sidelink (SL) carrier selection or reselection, synchronization of aggregated carriers, power control for simultaneous sidelink transmission (Tx), and packet duplication. Some systems, however, limit such support to intra-band CA for the ITS band in frequency range 1 (FR1) (e.g., band n47). Further, certain systems provide no specific enhancements for sidelink features with sidelink CA support.

Certain NR sidelink features may be backwards compatible. For example, a legacy UE may receive sidelink broadcast and/or groupcast transmissions with CA for the carrier on which it receives PSCCH/PSSCH and may transmit the corresponding sidelink HARQ feedback (e.g., when SL-HARQ is enabled in the SCI). However, certain systems only support NR sidelink features for mode 2 operations.

Certain systems use the same subcarrier spacing (SCS) among CA carriers to avoid resource selection enhancements and automatic gain control (AGC) issues. The time resources for PSFCH may be aligned among the carriers for the CA. However, in certain multi-carrier systems there may be no enhancements related to SCI transmissions on PSCCH/PSSCH, PSFCH transmissions, reference signal received power (RSRP) feedback, channel state information (CSI) feedback, and/or congestion control (i.e., compared to per-carrier operation). Thus, in such systems, the SL resource indication may remain to be per-resource pool and per-carrier basis (i.e., no cross-carrier scheduling in the SCI) and the UE may transmit the SL HARQ feedback on the same carrier on which it receives the associated PSSCH. Further, there may be no support for limited transmission and reception capability and there may be no primary or secondary carrier differentiation.

Like LTE sidelink CA, NR sidelink CA includes sidelink carrier selection or reselection, synchronization of aggregated carriers, Tx power split for simultaneous sidelink transmissions, and packet duplication. In certain wireless systems, the CA band combination may be limited to intra-band contiguous CA.

### LTE V2X Power Allocation Among Multiple Carriers

By way of example, the SL CA may be used in vehicle to everything (V2X) use cases. In LTE V2X, multiple carrier (multi-carrier) operation may be supported. If there is overlap in one transmission time interval (TTI) and the UE is not able to transmit simultaneously on multiple carriers due to varying amounts of available power, the UE may prioritize transmission on the higher priority packets. If there is overlap in one TTI of the same priority packets in different carriers, then it may be left to UE implementation to perform transmission if the UE is constrained in terms of available power. In case of conflict with uplink transmission, specified rules in wireless systems may be used with respect to uplink transmissions.

### NR Sidelink Power Allocation for PSFCH

In NR sidelink, simultaneous multiple PSFCH transmissions in a carrier may be supported and may provide the following definitions. Nₘₐₓ (also referred to as N_{max,PSFCH}) is UE capability of maximum number of simultaneous PSFCH transmissions. N_{sch} (also referred to as N_{sch,Tx,PSFCH}) is a UE (e.g., ideally) scheduled number of simultaneous PSFCH transmissions. Pₒₙₑ (also referred to as N_{PSFCH,one}) is an (e.g., ideal) transmission power of a single PSFCH transmission, which may be based on downlink pathloss. P_{CMAX} is a total transmission power of a UE. N_{Tx} (also referred to as N_{Tx,PSFCH}) is a UE's actual number of simultaneous PSFCH transmissions. PTx (also referred to as P_{Tx,PSFCH} or P_{PSFCH,k} for a PSFCH transmission k, 1≤k≤N_{Tx,PSFCH}) is a UE's actual transmission power of each PSFCH.

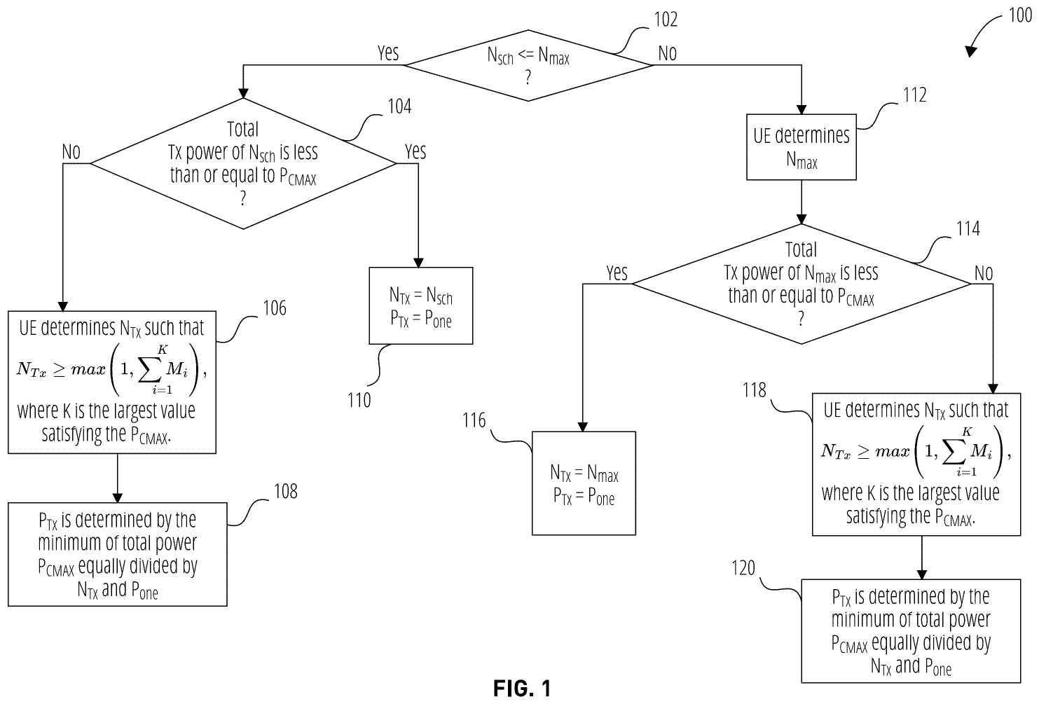

FIG. 1 illustrates an example method 100 for NR sidelink power allocation for PSFCH used in certain wireless systems. In block 102 of the method 100, the UE determines whether N_{sch} is less than or equal to (<=) Nₘₐₓ. If yes, in block 104, the UE determines whether a total Tx power of N_{sch} is less than or equal to P_{CMAX}. If no, at block 106, the UE determines N_{Tx} such that N_{Tx}≥max(1, Σᵢ₌₁^{K}Mᵢ), where K is a largest value satisfying the total transmission power P_{CMAX} of the UE, i is a priority value, and Mᵢ is a number of the prioritized PSFCHs with the priority value i. At block 108, the UE determines P_{Tx} by the minimum of total power P_{CMAX} equally divided by N_{Tx} and Pₒₙₑ. At block 104, when the UE determines that the total Tx power of N_{sch} is less than or equal to P_{CMAX}, at block 110, the UE sets N_{Tx}=N_{sch} and P_{Tx}=Pₒₙₑ.

If, at block 102, the UE determines that N_{sch}<=Nₘₐₓ is not true, then the UE, at block 112 determines Nₘₐₓ. Then, at block 114, the UE determines whether the total Tx power of Nₘₐₓ is less than or equal to P_{CMAX}. If yes, at block 116, the UE sets N_{Tx}=Nₘₐₓ and P_{Tx}=Pₒₙₑ. If no at block 114, then at block 118 the UE determines N_{Tx} such that N_{Tx}≥max(1, Σᵢ₌₁^{K}Mᵢ), where K is a largest value satisfying the total transmission power PCMAX of the UE, i is a priority value, and Mᵢ is a number of the prioritized PSFCHs with the priority value i. At block 120, the UE determines P_{Tx} by the minimum of total power P_{CMAX} equally divided by N_{Tx} and Pₒₙₑ.

For the example method 100 shown in FIG. 1, certain wireless systems may encounter problems of how to allocate transmission power of PSFCH in multi-carrier cases. Thus, certain embodiments disclosed herein include prioritizing the PSFCH with a higher priority across multiple carriers. Other embodiments include prioritizing the carrier first, and then prioritizing the PSFCH with a higher priority within each carrier.

Further, for the example method 100 shown in FIG. 1, certain wireless systems may encounter problems of how to allocate transmit power of SL transmissions over multiple carriers and uplink (UL) transmissions. Thus, certain embodiments disclosed herein include carrier based prioritization, link based prioritization, and/or sidelink physical channel based prioritization.

### Power Allocation for PSFCH Transmissions in Multi-Carrier

In certain embodiments, a UE is configured to prioritize PSFCH transmissions with higher priority across multiple carriers. For example, when a UE is to simultaneously transmit PSFCHs on multiple carriers, the UE performs procedures for a single carrier by considering all the PSFCHs for transmission using a corresponding N_{max,PSFCH} and P_{CMAX} in order to determine PSFCHs to transmit and a corresponding power per PSFCH transmission. The UE expects to be provided a configuration or preconfiguration such that the PSFCH transmissions on the multiple carriers are with time resource alignment and a same power.

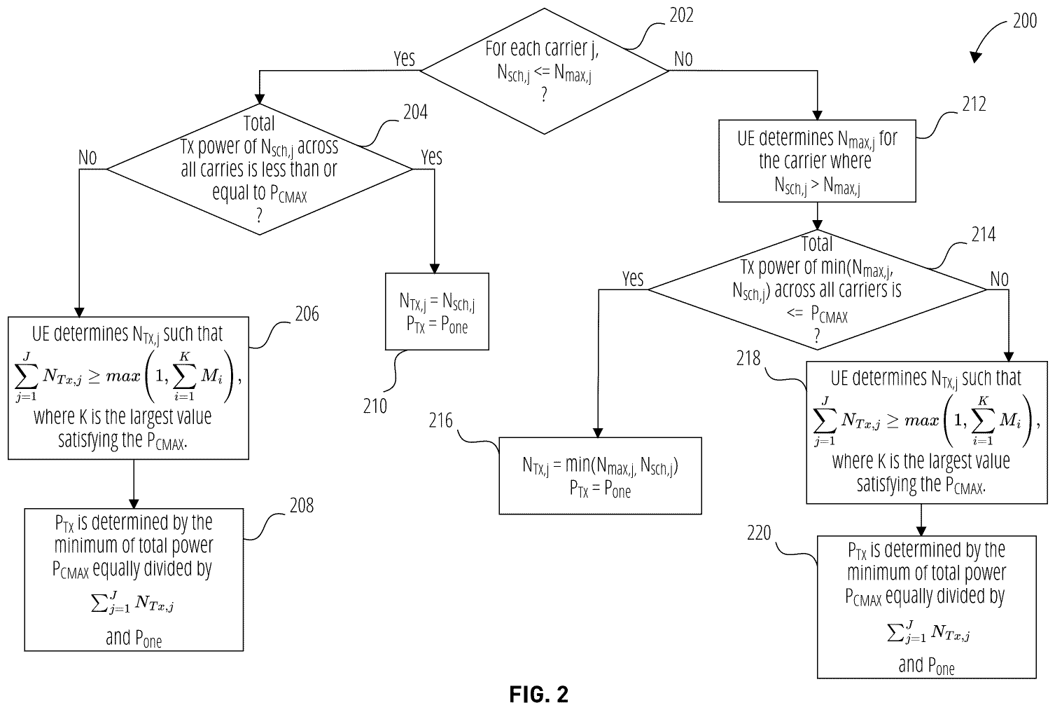

For example, FIG. 2 illustrates an example method 200 for PSFCH power allocation on multiple carries, according to certain embodiments. The method 200 may be used by the UE for determining, from among a plurality of PSFCHs scheduled for simultaneous transmission on the multiple carriers, prioritized PSFCHs to simultaneously transmit across the multiple carriers based at least in part on a capability of the UE for a maximum number N_{max,j} of simultaneous PSFCH transmissions per carrier of the multiple carriers and a total transmission power P_{CMAX} of the UE, where j is an index of a jth-carrier of the multiple carriers. The UE determines allocated transmission power for the prioritized PSFCHs, and simultaneously transmits the prioritized PSFCHs on the multiple carriers according to the allocated transmission power.

To determine the prioritized PSFCHs to simultaneously transmit, at block 202, for each of the multiple carriers, the UE determines whether a scheduled number N_{sch,j} of simultaneous PSFCH transmissions on the jth-carrier is less than or equal to the maximum number N_{max,j} of simultaneous PSFCH transmissions on the jth-carrier (i.e., for each carrier j, the UE determines whether N_{sch,j}<=N_{max,j}). If yes, at block 204, the UE determines whether a total Tx power (also referred to as a combined transmission power) of the scheduled number N_{sch,j} of simultaneous PSFCH transmissions across the multiple carriers is less than or equal to the total transmission power P_{CMAX} of the UE. If the total Tx power of the scheduled number N_{sch,j} of simultaneous PSFCH transmissions across the multiple carriers is not less than or equal to the total transmission power P_{CMAX}, at block 206, the UE determines an actual number N_{Tx,j} of simultaneous transmissions on the jth-carrier such that Σ₌₁^{J}N_{Tx,j}≥max(1, Σᵢ₌₁^{K}Mᵢ), where J is a total number of the multiple carriers, K is a largest value satisfying the total transmission power P_{CMAX} of the UE, i is a priority value, and Mᵢ is a number of the prioritized PSFCHs with the priority value i. At block 208, the UE determines an actual transmission power P_{Tx} of each of the prioritized PSFCHs as a minimum of the total transmission power P_{CMAX} equally divided by Σⱼ₌₁^{J}N_{Tx,j} and a transmission power Pₒₙₑ of a single PSFCH transmission.

When, at block 204, the total transmission power of the scheduled number N_{sch,j} of simultaneous PSFCH transmissions across the multiple carriers is less than or equal to the total transmission power P_{CMAX} of the UE, at block 210, the UE sets an actual number N_{Tx,j} of simultaneous transmissions on the jth-carrier equal to the scheduled number N_{sch,j} of simultaneous PSFCH transmissions on the jth-carrier, and sets an actual transmission power P_{Tx} of each of the prioritized PSFCHs equal to a transmission power Pₒₙₑ of a single PSFCH transmission.

Returning to block 202, for each of the multiple carriers, when a scheduled number N_{sch,j} of simultaneous PSFCH transmissions on the jth-carrier is not less than or equal to the maximum number N_{max,j} of simultaneous PSFCH transmissions on the jth-carrier, at block 212, the UE determines the maximum number N_{max,j} for the jth-carrier where N_{sch,j}>N_{max,j}. At block 214, the UE determines whether the total Tx power (i.e., combined transmission power) of min(N_{max,j}, N_{sch,j}) across the multiple carriers (e.g., all carriers) is less than or equal to the total transmission power P_{CMAX} of the UE. If no, at block 218, the UE determines an actual number N_{Tx,j} of simultaneous transmissions on the jth-carrier such that Σⱼ₌₁^{J}N_{Tx,j}>max(1, Σᵢ₌₁^{K}Mᵢ), where J is a total number of the multiple carriers, K is a largest value satisfying the total transmission power P_{CMAX} of the UE, i is a priority value, and Mᵢ is a number of the prioritized PSFCHs with the priority value i. At block 220, the UE determines an actual transmission power P_{Tx} of each of the prioritized PSFCHs as a minimum of the total transmission power P_{CMAX} equally divided by Σⱼ₌₁^{J}N_{Tx}, and a transmission power Pₒₙₑ of a single PSFCH transmission. If, at 214, the total Tx power of min(N_{max,j}, N_{sch,j}) across the multiple carriers (e.g., all carriers) is less than or equal to the total transmission power P_{CMAX}, at block 216, the UE sets an actual number N_{Tx,j} of simultaneous transmissions on the jth-carrier equal to the min(N_{max,j}, N_{sch,j}), and sets an actual transmission power P_{Tx} of each of the prioritized PSFCHs equal to a transmission power Pₒₙₑ of a single PSFCH transmission.

Thus, the method 200 allows a UE to prioritize the PSFCH transmissions with higher priority across multiple carriers (or across all carriers with PSFCH transmissions) at the same time. The UE may determine N_{Tx,j} by considering all the high priority PSFCH transmissions across all the carriers. Each PSFCH may have the same transmission power, which is determined by Σⱼ₌₁^{J}N_{Tx,j}, rather than N_{Tx}.

In certain embodiments, for NR sidelink CA, if there are simultaneous PSCCH/PSSCH/S-SSB (SL synchronization signal block) transmissions on multiple carriers and the UE has limited transmission power over all these carriers, then the UE prioritizes PSCCH/PSSCH/S-SSB transmission with higher priority.

In NR sidelink operations in a single carrier, simultaneous PSFCH transmissions is supported. The actual number of simultaneous PSFCH transmissions (N_{Tx,PSFCH}) is determined by the UE's capability of a maximum number of simultaneous PSFCH transmissions (N_{max,PSFCH}), scheduled number of PSFCH transmissions (N_{sch,Tx,PSFCH}), ideal single-PSFCH transmission power (P_{PSFCH,one}), the UE's total transmission power (P_{CMAX}), as well as the priorities of these PSFCH transmissions. In case of power limited scenario (i.e., P_{CMAX} is not large enough to support all the scheduled number of simultaneous PSFCH transmissions accompanied with ideal single-PSFCH transmission power), the PSFCHs to be transmitted are selected based on their priorities.

Once the actual number of simultaneous PSFCH transmissions is determined, the power of each of actual PSFCH transmission is the same. Specifically, in case of a power limited scenario, each PSFCH transmission power is equal to the UE's total transmission power equally divided by the actual number of simultaneous PSFCH transmissions. Otherwise, each PSFCH transmission power is equal to the ideal single-PSFCH transmission power.

In NR sidelink CA operation, if the UE's total transmission power is large enough to support all the scheduled simultaneous PSFCH transmissions across all the carriers accompanied with ideal single-PSFCH transmission power, then all the scheduled PSFCH transmissions across all carriers can occur, where each PSFCH transmission power is equal to the ideal single-PSFCH transmission power.

If the UE's total transmission power is not large enough to support all the scheduled simultaneous PSFCH transmissions across all the carriers, accompanied with ideal single-PSFCH transmission power, then only a subset of simultaneous PSFCH transmissions can occur. As described herein, two alternative embodiments may be used to determine the subset of PSFCHs for transmission.

In one embodiment, the selection of PSFCHs for transmission depends on their priorities, regardless of which carrier these PSFCHs are allocated. Specifically, a UE selects N_{Tx,PSFCH,j} on the j-th carrier, 0≤j≤J, such that N_{Tx,PSFCH}=Σⱼ₌₁^{J}N_{Tx,PSFCH,j}≥max(1, Σⱼ₌₁^{J}Σᵢ₌₁^{K}M_{i,j}), where M_{i,j} is the number of PSFCH with priority value i on the j-th carrier, and the value K is the largest value satisfying P_{PSFCH,one}+10 log₁₀(max(1, Σⱼ₌₁^{J}Σᵢ₌₁^{K}M_{i,j}))≤P_{CMAX}. In this approach, the power of each selected PSFCH transmission is the same, as in the legacy PSFCH transmission in a single carrier.

In another embodiment, the UE first prioritizes the carriers for PSFCH transmissions. For a high priority carrier, the subset of simultaneous PSFCHs transmissions, as well as the power of each actual PSFCH transmission, is determined following a PSFCH power control rule for a single sidelink carrier. If there are residual PSFCH transmission power after the power allocation on a high priority carrier, the residual PSFCH transmission power may be further allocated to a low priority carrier. Here, the prioritization of PSFCH transmission carriers may be configured, or may depend on the number of high priority PSFCH transmissions in each carrier.

In certain embodiments, in NR sidelink CA, if a UE's total transmission power is large enough to support all scheduled simultaneous PSFCH transmissions across all carriers, accompanied with ideal single-PSFCH transmission power, then all scheduled PSFCH transmissions across all carriers can occur, where each PSFCH transmission power is equal to the ideal single-PSFCH transmission power.

In certain embodiments, in NR sidelink CA, if a UE's total transmission power is not large enough to support all the scheduled simultaneous PSFCH transmissions across all the carriers, accompanied with ideal single-PSFCH transmission power, then down-select from the following two alternatives. In a first alternative, the selection of PSFCHs for transmission depends on their priorities, regardless of which carrier the PSFCHs are allocated. The power of each selected PSFCH transmission is the same. In a second alternative, the carrier(s) for PSFCH transmissions are prioritized. The PSFCH transmission power are first allocated among all PSFCH transmissions in a high priority carrier, following a PSFCH power control rule. If there are residual PSFCH transmission power, then the UE continues the PSFCH transmission power allocation in a low priority carrier, following the PSFCH power control rule. The prioritization of carriers for PSFCH transmissions is either configured or based on the number of high priority PSFCH transmissions in a carrier.

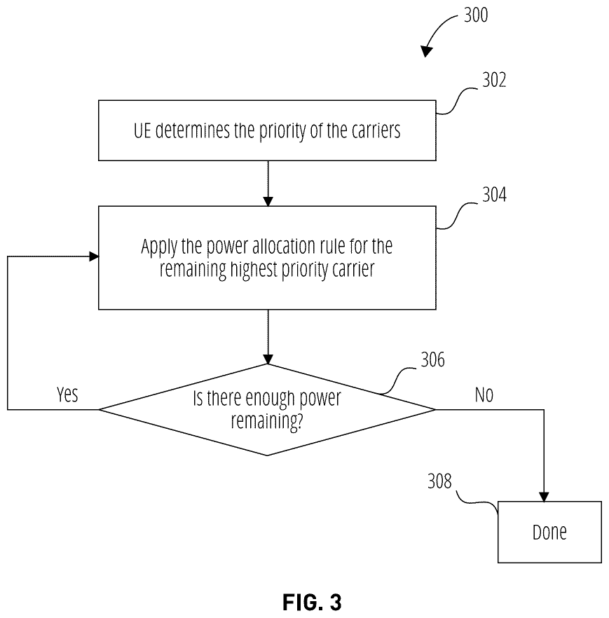

FIG. 3 illustrates an example alternative method 300 for power allocation for PSFCH transmission, according to certain embodiments. The example method 300 allows a UE to prioritize carriers first, and then to prioritize PSFCH with a higher priority within each carrier.

In a block 302 of the method 300, the UE determines the priority of the carries. In one alternative of the embodiment, the priority of the carrier may be determined semi-statically. For example, the resource pool (pre)configuration or PC5 radio resource configuration (RRC) configuration may specify which carrier has a higher priority to transmit the PSFCH. In a second alternative of the embodiment, the priority of the carrier may be determined dynamically. For example, the priority may depend on the scheduled number of higher priority PSFCH transmissions on each carrier. For N_{i,j} scheduled PSFCH transmissions on the j-th carrier, with priority value i, 1≤i≤8, if one carrier has a larger number of highest priority PSFCH transmissions as compared with another carrier, then the former carrier has a higher priority. If the number of highest priority PSFCH transmissions between carriers is equal, then the next level of priority of PSFCH transmissions may be compared. An example of dynamic determination of the priority of the carrier:
For i=1:8
   If N_{i,j1}>N_{i,j2}, then the j₁-th carrier has higher priority than j₂-th carrier; break the loop
   If N_{i,j1}<N_{i,j2}, then the j₂-th carrier has higher priority than j₁-th carrier; break the loop
If N_{i,j1}=N_{i,j2}, then i=i+1
End.

If there is a tie between two carriers, then it may be up to UE implementation to determine which carrier has higher priority.

The embodiments disclosed herein may not be limited to two carriers and may be applicable to multiple carriers. For example, in some embodiments there may be two carriers and in other embodiments there may be more than two carriers.

In block 304 of method 300, the UE applies the power allocation rule for the remaining highest priority carrier. P_{CMAX} may be replaced by P_{CMAX,res}, where P_{CMAX,res} P_{CMAX,res}−P_{Tx,j}, and where P_{Tx,j} is the total PSFCH transmission power for j-th carrier, which is implemented in block 306. Initially, P_{Tx,j}=0 and P_{CMAX,res}=P_{CMAX}.

In block 306 of the method 300, once the power allocation rule for the high priority carrier is applied, if there are remaining powers left after the higher priority carrier, the power for PSFCH transmissions in the lower priority carrier may be allocated. When there is enough remaining power, the method 300 returns to block 304. When there is not enough remaining power, the method 300 is done (i.e., complete) at block 308.

In some embodiments, criteria for determining whether there are remaining powers left after the j-th carrier (with high priority) may be when P_{Tx,j,one}=Pₒₙₑ, or when Pₒₙₑ+10 log₁₀(min(N_{sch,j},N_{max,j}))>P_{CMAX,res}, or when P_{CMAX,res}>=Pₒₙₑ. P_{CMAX,res} is the residual transmission power before the power allocation for the j-th carrier.

Power Allocation for SL Transmissions Over Multiple Carriers with UL Tx

In certain embodiment, power allocation for SL transmission over multiple carriers with UL Tx may include carrier based power reduction. For example, SL carrier 1, SL carrier 2 vs. UL. General principles for carrier based power reduction may include: treating each SL carrier separately; determining the highest priority among all overlapping transmissions within each SL carrier; comparing the highest priority of each SL carrier with UL; and/or the carrier with the highest priority transmission may have the priority of satisfying power allocation.

For example, if a UE is capable of simultaneous transmissions on the UL and on the SL in two or more respective carriers, the UE would transmit on the UL and on the SL in the two or more respective carriers, the transmission on the UL would overlap with the transmission on the SL over a time period, and the total UE transmission power over the time period would exceed P_{CMAX}, then the UE may reduce the power for the UL transmission prior to the start of the UL transmission, if any SL transmission on a carrier has higher priority than the UL transmission, so that the total UE transmission power would not exceed P_{CMAX}. The UE also reduces the power for the SL transmission on a carrier prior to the start of the SL transmission on a carrier, if the UL transmission has higher priority than all the SL transmission on a carrier so that the total UE transmission power would not exceed P_{CMAX}.

For example, if the SL carrier 1 Tx (PSSCH/PSCCH, S-SSB, or PSFCH) has a higher priority than UL Tx, while SL carrier 2 (PSSCH/PSCCH, S-SSB, or PSFCH) Tx has lower priority than UL, then first the Tx power for SL carrier 1 may be ensured, then the Tx power of UL may be ensured and, lastly, the Tx power on SL carrier 2 may be ensured. In other words, the Tx power on SL carrier 2 may first be reduced, then the Tx power on UL may be reduced, and so on.

In other embodiments, power allocation for SL transmission over multiple carriers with UL Tx may include link based power reduction. For example, SL vs. UL. General principles for link based power reduction may include: treating all SL carriers as a whole; determining the highest priority among all overlapping transmissions across all SL carriers; and/or comparing the highest priority across all SL carriers with UL. The link (either SL or UL) with the higher priority transmission may have the priority of satisfying power allocation.

For example, if a UE is capable of simultaneous transmissions on the UL and on the SL in two or more respective carriers, would transmit on the UL and on the SL in the two or more respective carriers, the transmission on the UL would overlap with the transmission on the SL over a time period, and the total UE transmission power over the time period would exceed P_{CMAX}, then the UE may reduce the power for the UL transmission prior to the start of the UL transmission, if any SL transmission on any carrier has higher priority than the UL transmission, so that the total UE transmission power would not exceed P_{CMAX}. The UE may also reduce the power for the SL transmission on all carriers prior to the start of the SL transmission on all carriers, if the UL transmission has higher priority than the SL transmission on all carriers so that the total UE transmission power would not exceed P_{CMAX}.

For example, if SL carrier 1 Tx (PSSCH/PSCCH, S-SSB, or PSFCH) has a higher priority than UL Tx, while SL carrier 2 (PSSCH/PSCCH, S-SSB, or PSFCH) Tx has a lower priority than UL, then the Tx power for SL carrier 1 and SL carrier 2 may first be ensured, then the Tx power of UL may be ensured. In other words, the Tx power on UL may first be reduced, then the Tx power on SL may be reduced.

In another embodiment, power allocation for SL transmission over multiple carriers with UL Tx may include sidelink physical channel based power reduction. For example, PSFCH, PSSCH/PSCCH, S-SSB vs. UL. General principles for sidelink physical channel based power reduction may include: treating each physical channel (e.g., PSFCH, PSCCH/PSSCH, S-SSB) among different SL carriers separately; determining the highest priority among all overlapping physical channel transmissions across all SL carriers; and/or comparing the highest priority of the physical channels with the UL. The physical channel with the higher priority transmission may have the priority of satisfying power allocation.

For example, if a UE is capable of simultaneous transmissions on the UL and on the SL in two or more respective carriers, would transmit on the UL and on the SL in the two or more respective carriers, the transmission on the UL would overlap with the transmission on the SL over a time period, and the total UE transmission power over the time period would exceed P_{CMAX}, then the UE may reduce the power for the UL transmission prior to the start of the UL transmission, if the SL transmission on a carrier has higher priority than the UL transmission so that the total UE transmission power would not exceed P_{CMAX}. The UE may also reduce the power for a SL transmission on a carrier prior to the start of the SL transmission, if the UL transmission has higher priority than the SL transmission, so that the total UE transmission power would not exceed P_{CMAX}.

For example, if SL carrier 1 Tx (PSFCH) and SL carrier 2 Tx (PSFCH) has a higher priority than UL Tx, while SL carrier 1 (PSSCH/PSCCH) and SL carrier 2 (PSSCH/PSCCH) Tx has a lower priority than UL, then the Tx power for SL carrier 1 (PSFCH) and SL carrier 2 (PSFCH) may first be ensured, then the Tx power of UL may be ensured, and lastly the Tx power of SL carrier 1 (PSSCH/PSCCH) and SL carrier 2 (PSSCH/PSCCH) may be ensured.

### Example Architecture

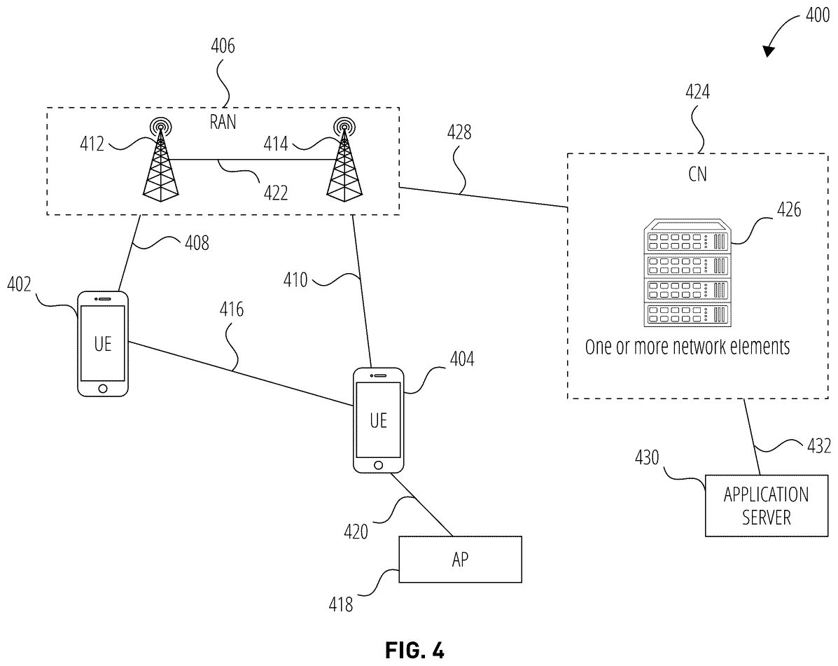

FIG. 4 illustrates an example architecture of a wireless communication system 400, according to embodiments disclosed herein. The following description is provided for an example wireless communication system 400 that operates in conjunction with the LTE system standards and/or 5G or NR system standards as provided by 3GPP technical specifications.

As shown by FIG. 4, the wireless communication system 400 includes UE 402 and UE 404 (although any number of UEs may be used). In this example, the UE 402 and the UE 404 are illustrated as smartphones (e.g., handheld touchscreen mobile computing devices connectable to one or more cellular networks), but may also comprise any mobile or non-mobile computing device configured for wireless communication.

The UE 402 and UE 404 may be configured to communicatively couple with a RAN 406. In embodiments, the RAN 406 may be NG-RAN, E-UTRAN, etc. The UE 402 and UE 404 utilize connections (or channels) (shown as connection 408 and connection 410, respectively) with the RAN 406, each of which comprises a physical communications interface. The RAN 406 can include one or more base stations (such as base station 412 and base station 414) that enable the connection 408 and connection 410.

In this example, the connection 408 and connection 410 are air interfaces to enable such communicative coupling, and may be consistent with RAT(s) used by the RAN 406, such as, for example, an LTE and/or NR.

In some embodiments, the UE 402 and UE 404 may also directly exchange communication data via a sidelink interface 416. The sidelink interface 416 may comprise a PC5 interface. As disclosed herein, certain embodiments may use sidelink feedback for the sidelink interface 416. As described in detail herein, such embodiments may include determining, from among a plurality of PSFCHs scheduled for simultaneous transmission on the multiple carriers, prioritized PSFCHs to simultaneously transmit across the multiple carriers based at least in part on a capability of the UE for a maximum number N_{max,j} of simultaneous PSFCH transmissions per carrier of the multiple carriers and a total transmission power P_{CMAX} of the UE, where j is an index of a jth-carrier of the multiple carriers.

The UE 404 is shown to be configured to access an access point (shown as AP 418) via connection 420. By way of example, the connection 420 can comprise a local wireless connection, such as a connection consistent with any IEEE 802.11 protocol, wherein the AP 418 may comprise a Wi-Fi® router. In this example, the AP 418 may be connected to another network (for example, the Internet) without going through a CN 424.

In embodiments, the UE 402 and UE 404 can be configured to communicate using orthogonal frequency division multiplexing (OFDM) communication signals with each other or with the base station 412 and/or the base station 414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 412 or base station 414 may be implemented as one or more software entities running on server computers as part of a virtual network. In addition, or in other embodiments, the base station 412 or base station 414 may be configured to communicate with one another via interface 422. In embodiments where the wireless communication system 400 is an LTE system (e.g., when the CN 424 is an EPC), the interface 422 may be an X2 interface. The X2 interface may be defined between two or more base stations (e.g., two or more eNBs and the like) that connect to an EPC, and/or between two eNBs connecting to the EPC. In embodiments where the wireless communication system 400 is an NR system (e.g., when CN 424 is a 5GC), the interface 422 may be an Xn interface. The Xn interface is defined between two or more base stations (e.g., two or more gNBs and the like) that connect to 5GC, between a base station 412 (e.g., a gNB) connecting to 5GC and an eNB, and/or between two eNBs connecting to 5GC (e.g., CN 424).

The RAN 406 is shown to be communicatively coupled to the CN 424. The CN 424 may comprise one or more network elements 426, which are configured to offer various data and telecommunications services to customers/subscribers (e.g., users of UE 402 and UE 404) who are connected to the CN 424 via the RAN 406. The components of the CN 424 may be implemented in one physical device or separate physical devices including components to read and execute instructions from a machine-readable or computer-readable medium (e.g., a non-transitory machine-readable storage medium).

In embodiments, the CN 424 may be an EPC, and the RAN 406 may be connected with the CN 424 via an S1 interface 428. In embodiments, the S1 interface 428 may be split into two parts, an S1 user plane (S1-U) interface, which carries traffic data between the base station 412 or base station 414 and a serving gateway (S-GW), and the S1-MME interface, which is a signaling interface between the base station 412 or base station 414 and mobility management entities (MMEs).

In embodiments, the CN 424 may be a 5GC, and the RAN 406 may be connected with the CN 424 via an NG interface 428. In embodiments, the NG interface 428 may be split into two parts, an NG user plane (NG-U) interface, which carries traffic data between the base station 412 or base station 414 and a user plane function (UPF), and the S1 control plane (NG-C) interface, which is a signaling interface between the base station 412 or base station 414 and access and mobility management functions (AMFs).

Generally, an application server 430 may be an element offering applications that use internet protocol (IP) bearer resources with the CN 424 (e.g., packet switched data services). The application server 430 can also be configured to support one or more communication services (e.g., VoIP sessions, group communication sessions, etc.) for the UE 402 and UE 404 via the CN 424. The application server 430 may communicate with the CN 424 through an IP communications interface 432.

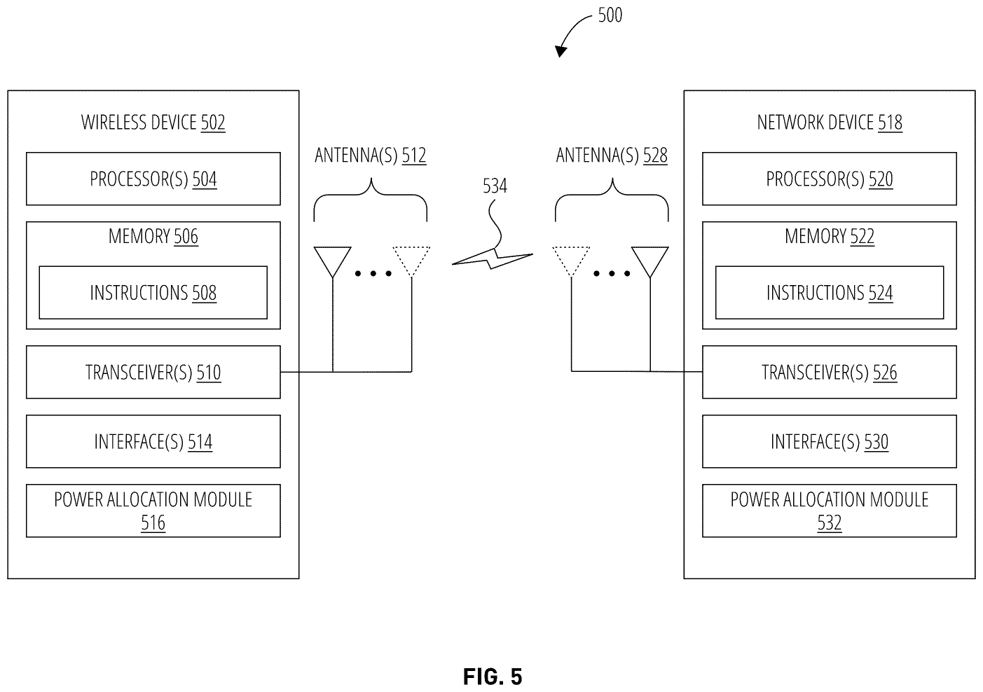

FIG. 5 illustrates a system 500 for performing signaling 534 between a wireless device 502 and a network device 518, according to embodiments disclosed herein. The system 500 may be a portion of a wireless communications system as herein described. The wireless device 502 may be, for example, a UE of a wireless communication system. The network device 518 may be, for example, a base station (e.g., an eNB or a gNB) of a wireless communication system.

The wireless device 502 may include one or more processor(s) 504. The processor(s) 504 may execute instructions such that various operations of the wireless device 502 are performed, as described herein. The processor(s) 504 may include one or more baseband processors including processing circuitry implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 502 may include a memory 506. The memory 506 may be a non-transitory computer-readable storage medium that stores instructions 508 (which may include, for example, the instructions being executed by the processor(s) 504). The instructions 508 may also be referred to as program code or a computer program. The memory 506 may also store data used by, and results computed by, the processor(s) 504.

The wireless device 502 may include one or more transceiver(s) 510 that may include radio frequency (RF) transmitter circuitry and/or receiver circuitry that use the antenna(s) 512 of the wireless device 502 to facilitate signaling (e.g., the signaling 534) to and/or from the wireless device 502 with other devices (e.g., the network device 518) according to corresponding RATs.

The wireless device 502 may include one or more antenna(s) 512 (e.g., one, two, four, or more). For embodiments with multiple antenna(s) 512, the wireless device 502 may leverage the spatial diversity of such multiple antenna(s) 512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 502 may be accomplished according to precoding (or digital beamforming) that is applied at the wireless device 502 that multiplexes the data streams across the antenna(s) 512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 502 may implement analog beamforming techniques, whereby phases of the signals sent by the antenna(s) 512 are relatively adjusted such that the (joint) transmission of the antenna(s) 512 can be directed (this is sometimes referred to as beam steering).

The wireless device 502 may include one or more interface(s) 514. The interface(s) 514 may be used to provide input to or output from the wireless device 502. For example, a wireless device 502 that is a UE may include interface(s) 514 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 510/antenna(s) 512 already described) that allow for communication between the UE and other devices and may operate according to known protocols (e.g., Wi-Fi®, Bluetooth©, and the like).

The wireless device 502 may include a power allocation module 516. The power allocation module 516 may be implemented via hardware, software, or combinations thereof. For example, the power allocation module 516 may be implemented as a processor, circuit, and/or instructions 508 stored in the memory 506 and executed by the processor(s) 504. In some examples, the power allocation module 516 may be integrated within the processor(s) 504 and/or the transceiver(s) 510. For example, the power allocation module 516 may be implemented by a combination of software components (e.g., executed by a DSP or a general processor) and hardware components (e.g., logic gates and circuitry) within the processor(s) 504 or the transceiver(s) 510.

The power allocation module 516 may be used for various aspects of the present disclosure. The power allocation module 516 may be configured to perform the UE-based methods disclosed herein. For example, the power allocation module 516 may be configured to determine, from among a plurality of PSFCHs scheduled for simultaneous transmission on the multiple carriers, prioritized PSFCH s to simultaneously transmit across the multiple carriers based at least in part on a capability of the UE for a maximum number N_{max,j} of simultaneous PSFCH transmissions per carrier of the multiple carriers and a total transmission power P_{CMAX} of the UE, where j is an index of a jth-carrier of the multiple carriers.

The network device 518 may include one or more processor(s) 520. The processor(s) 520 may execute instructions such that various operations of the network device 518 are performed, as described herein. The processor(s) 520 may include one or more baseband processors implemented using, for example, a CPU, a DSP, an ASIC, a controller, an FPGA device, another hardware device, a firmware device, or any combination thereof configured to perform the operations described herein.

The network device 518 may include a memory 522. The memory 522 may be a non-transitory computer-readable storage medium that stores instructions 524 (which may include, for example, the instructions being executed by the processor(s) 520). The instructions 524 may also be referred to as program code or a computer program. The memory 522 may also store data used by, and results computed by, the processor(s) 520.

The network device 518 may include one or more transceiver(s) 526 that may include RF transmitter circuitry and/or receiver circuitry that use the antenna(s) 528 of the network device 518 to facilitate signaling (e.g., the signaling 534) to and/or from the network device 518 with other devices (e.g., the wireless device 502) according to corresponding RATs.

The network device 518 may include one or more antenna(s) 528 (e.g., one, two, four, or more). In embodiments having multiple antenna(s) 528, the network device 518 may perform MIMO, digital beamforming, analog beamforming, beam steering, etc., as has been described.

The network device 518 may include one or more interface(s) 530. The interface(s) 530 may be used to provide input to or output from the network device 518. For example, a network device 518 that is a base station may include interface(s) 530 made up of transmitters, receivers, and other circuitry (e.g., other than the transceiver(s) 526/antenna(s) 528 already described) that enables the base station to communicate with other equipment in a core network, and/or that enables the base station to communicate with external networks, computers, databases, and the like for purposes of operations, administration, and maintenance of the base station or other equipment operably connected thereto.

The network device 518 may include a power allocation module 532. The power allocation module 532 may be implemented via hardware, software, or combinations thereof. For example, the power allocation module 532 may be implemented as a processor, circuit, and/or instructions 524 stored in the memory 522 and executed by the processor(s) 520. In some examples, the power allocation module 532 may be integrated within the processor(s) 520 and/or the transceiver(s) 526. For example, the power allocation module 532 may be implemented by a combination of software components (e.g., executed by a DSP or a general processor) and hardware components (e.g., logic gates and circuitry) within the processor(s) 520 or the transceiver(s) 526.

The power allocation module 532 may be used for various aspects of the present disclosure. For example, the power allocation module 532 may configure resources and/or provide configuration information to the wireless device 502 to prioritize PSFCH transmissions with higher priority across multi-carriers.

Embodiments contemplated herein include an apparatus comprising means to perform one or more elements of the UE-based methods disclosed herein. This apparatus may be, for example, an apparatus of a UE (such as a wireless device 502 that is a UE, as described herein).

Embodiments contemplated herein include one or more non-transitory computer-readable media comprising instructions to cause an electronic device, upon execution of the instructions by one or more processors of the electronic device, to perform one or more elements of the UE-based methods disclosed herein. This non-transitory computer-readable media may be, for example, a memory of a UE (such as a memory 506 of a wireless device 502 that is a UE, as described herein).

Embodiments contemplated herein include an apparatus comprising logic, modules, or circuitry to perform one or more elements of the UE-based methods disclosed herein. This apparatus may be, for example, an apparatus of a UE (such as a wireless device 502 that is a UE, as described herein).

Embodiments contemplated herein include an apparatus comprising: one or more processors and one or more computer-readable media comprising instructions that, when executed by the one or more processors, cause the one or more processors to perform one or more elements of the UE-based methods disclosed herein. This apparatus may be, for example, an apparatus of a UE (such as a wireless device 502 that is a UE, as described herein).

Embodiments contemplated herein include a signal as described in or related to one or more elements of the UE-based methods disclosed herein.

Embodiments contemplated herein include a computer program or computer program product comprising instructions, wherein execution of the program by a processor is to cause the processor to carry out one or more elements of the UE-based methods disclosed herein. The processor may be a processor of a UE (such as a processor(s) 504 of a wireless device 502 that is a UE, as described herein). These instructions may be, for example, located in the processor and/or on a memory of the UE (such as a memory 506 of a wireless device 502 that is a UE, as described herein).

Embodiments contemplated herein include an apparatus comprising means to perform one or more elements of the network-based methods disclosed herein. This apparatus may be, for example, an apparatus of a base station (such as a network device 518 that is a base station, as described herein).

Embodiments contemplated herein include one or more non-transitory computer-readable media comprising instructions to cause an electronic device, upon execution of the instructions by one or more processors of the electronic device, to perform one or more elements of the network-based methods disclosed herein. This non-transitory computer-readable media may be, for example, a memory of a base station (such as a memory 522 of a network device 518 that is a base station, as described herein).

Embodiments contemplated herein include an apparatus comprising logic, modules, or circuitry to perform one or more elements of the network-based methods disclosed herein. This apparatus may be, for example, an apparatus of a base station (such as a network device 518 that is a base station, as described herein).

Embodiments contemplated herein include an apparatus comprising: one or more processors and one or more computer-readable media comprising instructions that, when executed by the one or more processors, cause the one or more processors to perform one or more elements of the network-based methods disclosed herein. This apparatus may be, for example, an apparatus of a base station (such as a network device 518 that is a base station, as described herein).

Embodiments contemplated herein include a signal as described in or related to one or more elements of the network-based methods disclosed herein.

Embodiments contemplated herein include a computer program or computer program product comprising instructions, wherein execution of the program by a processing element is to cause the processing element to carry out one or more elements of the network-based methods disclosed herein. The processor may be a processor of a base station (such as a processor(s) 520 of a network device 518 that is a base station, as described herein). These instructions may be, for example, located in the processor and/or on a memory of the base station (such as a memory 522 of a network device 518 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus to be used in a user equipment (UE), the apparatus comprising:
processing circuitry, wherein to configure the UE for sidelink power allocation on multiple carriers, the processing circuitry is to:
determine, from among a plurality of physical sidelink feedback channels (PSFCHs) scheduled for simultaneous transmission on the multiple carriers, prioritized PSFCHs to simultaneously transmit across the multiple carriers based at least in part on a capability of the UE for a maximum number N_{max,j} of simultaneous PSFCH transmissions per carrier of the multiple carriers and a total transmission power P_{CMAX} of the UE, where j is an index of a jth-carrier of the multiple carriers;
determine allocated transmission power for the prioritized PSFCHs; and
encode, for simultaneous transmission, the prioritized PSFCHs on the multiple carriers according to the allocated transmission power.

2. The apparatus of claim 1, wherein to determine the prioritized PSFCHs to simultaneously transmit, the baseband processor is further configured to:
for each of the multiple carriers, when a scheduled number N_{sch,j} of simultaneous PSFCH transmissions on the jth-carrier is less than or equal to the maximum number N_{max,j} of simultaneous PSFCH transmissions on the jth-carrier, and
when a combined transmission power of the scheduled number N_{sch,j} of simultaneous PSFCH transmissions across the multiple carriers is not less than or equal to the total transmission power P_{CMAX} of the UE,
determine an actual number N_{Tx,j} of simultaneous transmissions on the jth-carrier such that Σⱼ₌₁^{J}N_{Tx,j}≥max(1, Σᵢ₌₁^{K}Mᵢ), where J is a total number of the multiple carriers, K is a largest value satisfying the total transmission power P_{CMAX} of the UE, i is a priority value, and Mᵢ is a number of the prioritized PSFCHs with the priority value i.

3. The apparatus of claim 2, wherein to determine the allocated transmission power, the baseband processor is further configured to determine an actual transmission power P_{Tx} of each of the prioritized PSFCHs as a minimum of the total transmission power P_{CMAX} equally divided by Σⱼ₌₁^{J}N_{Tx,j} and a transmission power Pₒₙₑ of a single PSFCH transmission.

4. The apparatus of claim 2, wherein the baseband processor is further configured to, when the combined transmission power of the scheduled number N_{sch,j} of simultaneous PSFCH transmissions across the multiple carriers is less than or equal to the total transmission power P_{CMAX} of the UE:
set an actual number N_{Tx,j} of simultaneous transmissions on the jth-carrier equal to the scheduled number N_{sch,j} of simultaneous PSFCH transmissions on the jth-carrier; and
set an actual transmission power P_{Tx} of each of the prioritized PSFCHs equal to a transmission power Pₒₙₑ of a single PSFCH transmission.

5. The apparatus of claim 1, wherein to determine the prioritized PSFCHs to simultaneously transmit, the baseband processor is further configured to:
for each of the multiple carriers, when a scheduled number N_{sch,j} of simultaneous PSFCH transmissions on the jth-carrier is not less than or equal to the maximum number N_{max,j} of simultaneous PSFCH transmissions on the jth-carrier,
determine the maximum number N_{max,j} for the jth-carrier where N_{sch,j}>N_{max,j}.

6. The apparatus of claim 5, wherein the baseband processor is further configured to:
when a combined transmission power of min(N_{max,j}, N_{sch,j}) across the multiple carriers is not less than or equal to the total transmission power P_{CMAX} of the UE,
determine an actual number N_{Tx,j} of simultaneous transmissions on the jth-carrier such that Σⱼ₌₁^{J}N_{Tx,j}≥max(1, Σᵢ₌₁^{K}Mᵢ), where J is a total number of the multiple carriers, K is a largest value satisfying the total transmission power P_{CMAX} of the UE, i is a priority value, and Mᵢ is a number of the prioritized PSFCHs with the priority value i.

7. The apparatus of claim 6, wherein to determine the allocated transmission power, the baseband processor is further configured to determine an actual transmission power P_{Tx} of each of the prioritized PSFCHs as a minimum of the total transmission power P_{CMAX} equally divided by Σⱼ₌₁^{J}N_{Tx,j} and a transmission power Pₒₙₑ of a single PSFCH transmission.

8. The apparatus of claim 5, wherein the baseband processor is further configured to:
when a combined transmission power of min(N_{max,j}, N_{sch,j}) across the multiple carriers is less than or equal to the total transmission power P_{CMAX} of the UE,
set an actual number N_{Tx,j} of simultaneous transmissions on the jth-carrier equal to the min(N_{max,j}, N_{sch,j}); and
set an actual transmission power P_{Tx} of each of the prioritized PSFCHs equal to a transmission power Pₒₙₑ of a single PSFCH transmission.

9. A method for a user equipment (UE) to control sidelink power allocation on multiple carriers, the method comprising:
determining, from among a plurality of physical sidelink feedback channels (PSFCHs) scheduled for simultaneous transmission on the multiple carriers, prioritized PSFCHs to simultaneously transmit across the multiple carriers based at least in part on a capability of the UE for a maximum number N_{max,j} of simultaneous PSFCH transmissions per carrier of the multiple carriers and a total transmission power P_{CMAX} of the UE, where j is an index of a jth-carrier of the multiple carriers;
determining allocated transmission power for the prioritized PSFCHs; and
simultaneously transmitting the prioritized PSFCHs on the multiple carriers according to the allocated transmission power.

10. The method of claim 9, wherein determining the prioritized PSFCHs to simultaneously transmit comprises:
for each of the multiple carriers, when a scheduled number N_{sch,j} of simultaneous PSFCH transmissions on the jth-carrier is less than or equal to the maximum number N_{max,j} of simultaneous PSFCH transmissions on the jth-carrier, and
when a combined transmission power of the scheduled number N_{sch,j} of simultaneous PSFCH transmissions across the multiple carriers is not less than or equal to the total transmission power P_{CMAX} of the UE,
determining an actual number N_{Tx,j} of simultaneous transmissions on the jth-carrier such that Σⱼ₌₁^{J}N_{Tx,j}≥max(1, Σᵢ₌₁^{K}Mᵢ), where J is a total number of the multiple carriers, K is a largest value satisfying the total transmission power P_{CMAX} of the UE, i is a priority value, and Mᵢ is a number of the prioritized PSFCHs with the priority value i.

11. The method of claim 10, wherein determining the allocated transmission power comprises determining an actual transmission power P_{Tx} of each of the prioritized PSFCHs as a minimum of the total transmission power P_{CMAX} equally divided by Σⱼ₌₁^{J}N_{Tx,j} and a transmission power Pₒₙₑ of a single PSFCH transmission.

12. The method of claim 10, further comprising, when the combined transmission power of the scheduled number N_{sch,j} of simultaneous PSFCH transmissions across the multiple carriers is less than or equal to the total transmission power P_{CMAX} of the UE:
setting an actual number N_{Tx,j} of simultaneous transmissions on the jth-carrier equal to the scheduled number N_{sch,j} of simultaneous PSFCH transmissions on the jth-carrier; and
setting an actual transmission power P_{Tx} of each of the prioritized PSFCHs equal to a transmission power Pₒₙₑ of a single PSFCH transmission.

13. The method of claim 9, wherein determining the prioritized PSFCHs to simultaneously transmit comprises:
for each of the multiple carriers, when a scheduled number N_{sch,j} of simultaneous PSFCH transmissions on the jth-carrier is not less than or equal to the maximum number N_{max,j} of simultaneous PSFCH transmissions on the jth-carrier,
determining the maximum number N_{max,j} for the jth-carrier where N_{sch,j}>N_{max,j}.

14. The method of claim 13, further comprising:
when a combined transmission power of min(N_{max,j}, N_{sch,j}) across the multiple carriers is not less than or equal to the total transmission power P_{CMAX} of the UE,
determining an actual number N_{Tx,j} of simultaneous transmissions on the jth-carrier such that Σⱼ₌₁^{J}N_{Tx,j}≥max(1, Σᵢ₌₁^{K}Mᵢ), where J is a total number of the multiple carriers, K is a largest value satisfying the total transmission power P_{CMAX} of the UE, i is a priority value, and Mᵢ is a number of the prioritized PSFCHs with the priority value i.

15. The method of claim 14, wherein determining the allocated transmission power comprises determining an actual transmission power P_{Tx} of each of the prioritized PSFCHs as a minimum of the total transmission power P_{CMAX} equally divided by Σⱼ₌₁^{J}N_{Tx,j} and a transmission power Pₒₙₑ of a single PSFCH transmission.

16. The method of claim 13, further comprising:
when a combined transmission power of min(N_{max,j}, N_{sch,j}) across the multiple carriers is less than or equal to the total transmission power P_{CMAX} of the UE,
setting an actual number N_{Tx,j} of simultaneous transmissions on the jth-carrier equal to the min(N_{max,j}, N_{sch,j}); and
setting an actual transmission power P_{Tx} of each of the prioritized PSFCHs equal to a transmission power Pₒₙₑ of a single PSFCH transmission.

17. A non-transitory computer-readable medium comprising instructions to cause a user equipment (UE), upon execution of the instructions by one or more processors of the UE, to:
determine, from among a plurality of physical sidelink feedback channels (PSFCHs) scheduled for simultaneous transmission on multiple carriers, prioritized PSFCHs to simultaneously transmit across the multiple carriers based at least in part on a capability of the UE for a maximum number N_{max,j} of simultaneous PSFCH transmissions per carrier of the multiple carriers and a total transmission power P_{CMAX} of the UE, where j is an index of a jth-carrier of the multiple carriers;
determine allocated transmission power for the prioritized PSFCHs; and
encode, for simultaneous transmission, the prioritized PSFCHs on the multiple carriers according to the allocated transmission power.

18. The non-transitory computer-readable medium of claim 17, wherein to determine the prioritized PSFCHs to simultaneously transmit, the baseband processor is further configured to:
for each of the multiple carriers, when a scheduled number N_{sch,j} of simultaneous PSFCH transmissions on the jth-carrier is less than or equal to the maximum number N_{max,j} of simultaneous PSFCH transmissions on the jth-carrier, and
when a combined transmission power of the scheduled number N_{sch,j} of simultaneous PSFCH transmissions across the multiple carriers is not less than or equal to the total transmission power P_{CMAX} of the UE,
determine an actual number N_{Tx,j} of simultaneous transmissions on the jth-carrier such that Σⱼ₌₁^{J}N_{Tx,j}≥max(1, Σᵢ₌₁^{K}Mᵢ), where J is a total number of the multiple carriers, K is a largest value satisfying the total transmission power P_{CMAX} of the UE, i is a priority value, and Mᵢ is a number of the prioritized PSFCHs with the priority value i.

19. The non-transitory computer-readable medium of claim 18, wherein to determine the allocated transmission power, the baseband processor is further configured to determine an actual transmission power P_{Tx} of each of the prioritized PSFCHs as a minimum of the total transmission power P_{CMAX} equally divided by Σⱼ₌₁^{J}N_{Tx,j} and a transmission power Pₒₙₑ of a single PSFCH transmission.

20. The non-transitory computer-readable medium of claim 18, wherein the baseband processor is further configured to, when the combined transmission power of the scheduled number N_{sch,j} of simultaneous PSFCH transmissions across the multiple carriers is less than or equal to the total transmission power P_{CMAX} of the UE:
set an actual number N_{Tx,j} of simultaneous transmissions on the jth-carrier equal to the scheduled number N_{sch,j} of simultaneous PSFCH transmissions on the jth-carrier; and
set an actual transmission power P_{Tx} of each of the prioritized PSFCHs equal to a transmission power Pₒₙₑ of a single PSFCH transmission.
